(19) United States
(12) Patent Application Publication
(10) Pub. No.: US 2006/0223488 A1
(43) Pub. Date: Oct. 5, 2006

(54) Method for the remote control of a venue, particularly a sales venue

(75) Inventor: Philippe Rambaud, Asnieres (FR)

Correspondence Address: OHLANDT, GREELEY, RUGGIERO & PERLE, LLP, ONE LANDMARK SQUARE, 10TH FLOOR, STAMFORD, CT, 06901, US

(73) Assignee: In-Touch Marketing Company, Paris (FR)

(21) Appl. No.: 10/563,186

(22) PCT Filed: Dec. 6, 2004
(86) PCT No.: PCT/FR04/03132

§ 371 Date: Dec. 30, 2005

(30) Foreign Application Priority Data
Dec. 8, 2003 (FR) 0314350

(51) Int. Cl. H04Q 7/20

(52) U.S. Cl. 455/403; 348/150

(57) ABSTRACT

In a remote monitoring process of a location, notably a sales location, of a type according to which images representing a part of the location are sent remotely to be centralized in a central monitoring device, the images are sent by means of a digital photographic device integrated into an MMS telephone and the digital images are transmitted at least partially via an electronic messaging network.

### BACKGROUND OF THE INVENTION

1. Field of the Invention

The present invention concerns a process for remote monitoring of a location and notably a sales location, in particular for the good application of a marketing standard.

2. Description of the Related Art

A process for remote monitoring of a location of the type in which images representing a part of the location are sent remotely to be centralized on a central monitoring device is known in a general way. Such a process is notably applied within the scope of surveillance of a premises, principally for security purposes, by means of cameras that can continuously or periodically send the images that they record to a central monitoring station. Such processes are cumbersome and costly and are only envisioned in cases where the need for constant surveillance is felt.

Now, the invention does not concern such a field, but it seeks to permit efficacious monitoring of a location and in particular a sales location, notably in order to analyze whether this sales location conforms to certain required standards. It can notably involve a sales location belonging to a chain of standardized stores, a franchise location or a local independent branch location, where it is important that sales are conducted under certain conditions, notably the presentation of products or marketing-sales methods and tools, conforming to very precise specifications. The elements to be monitored may be, for example, proposed stocking and restocking, out-of-stock items, the exact placement and presentation of products in the displays and the placement of the displays in the location itself, the displaying of prices, the decor, the exterior environment, etc.

Classically, the conformity of sales locations to standards is monitored by more-or-less regular visits by inspectors to the locations themselves. When the sales locations are numerous and geographically dispersed, one can conceive that such a method requires numerous and costly personnel, but nevertheless does not permit a sufficiently rapid and frequent recovery of information.

Devices for remote monitoring of the type employed in remote surveillance are generally too complicated and costly to be envisioned, at least in part, as a substitute solution for inspection visits.

### SUMMARY OF THE INVENTION

The object of the invention is to propose a process for remote monitoring of a location which can substitute in practice, at least partially, for actual visits, without requiring capital investments which would render them impractical.

The invention achieves its object by means of a remote monitoring process of a location, notably a sales location, of the type according to which images representing a part of the location are sent remotely to be centralized in a central monitoring device, characterized in that the images are sent by means of a digital photographic device integrated in a portable telephone of MMS technology (multimedia messaging services) transmitting the images to an electronic address corresponding to the central monitoring device.

Today, digital photographic devices are relatively inexpensive and by means of the generalization of the Internet and electronic messaging, digital images can easily be transmitted to a central monitoring device. According to the invention, the photographic device is combined with a portable MMS telephone (multimedia messaging services) transmitting the images to an electronic address corresponding to the central monitoring device. The photographic device may involve an external camera connected by wire or by wireless connection (Hertzian of the “Bluetooth” type, for example) to the MMS portable telephone, but, in a particularly advantageous manner, an MMS telephone with integrated camera is used. These devices, often designated under the name camera-phones or mobile phone cameras, very easily permit eliminating tiresome manipulations and instantly create and send digital photographs to the central monitoring device. The ease of use permits successfully obtaining the willingness of the location manager where the remote monitoring is applied, to regularly create photographs of the location at periodic intervals, for example three times a day, permitting regular follow-up from the central monitoring device. That this approach will work has been confirmed by tests.

The images received on the central device are compared to a standard and if they do not conform to the standard, a follow-up telephone call to the location where the non-conforming image originated is triggered and this will be integrated into the report of good deployment. All sorts of processing of the images received and of actions consecutive to the images received can be envisioned.

Naturally, according to the process of the invention, it is easy to manage a plurality of locations that are to be monitored in the same way. The savings of personnel dedicated to monitoring permits concentrating investments into actual visits only to the minor number of most profitable sites (empirically one-fifth of sites generate four-fifths of the gross sales) and treating the rest of the chain remotely with actual visits only in the case of recurrent or major problems.

The invention also concerns a device designed to implement the above process and comprises, on the one hand, at least one device for recording images representing a part of the location, and means for remotely sending the recorded images to be centralized in a central monitoring device, the device of the invention being characterized in that said device is a digital photographic device incorporated in a mobile phone with MMS technology (multimedia messaging services) transmitting the images to an electronic address corresponding to the central monitoring device.

### BRIEF DESCRIPTION OF THE DRAWINGS

Other characteristics and advantages of the invention will become apparent from the following description according to one example of embodiment. It will be made in reference to the attached drawings in which:

FIG. 1 schematically illustrates the principle of the process of the invention.

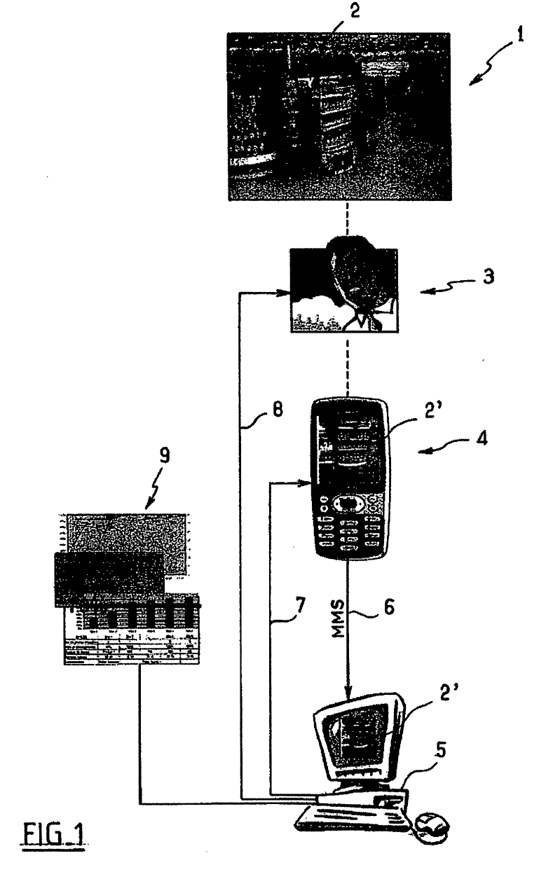

FIG. 2 is a graph showing the evolution over time of sending the photographs to the central device and the number of follow-ups.

### DESCRIPTION OF THE INVENTION

In the example of embodiment chosen, a location 1 to be monitored is a service station store and it involves more precisely monitoring the correct filling of a display 2 as a function of precise criteria defined by the policy for the sales sign presented. There are therefore specifications to be respected, both in terms of presentation (good arrangement and appearance of the products) as well as stocking (no out-of-stock items).

A site manager 3 is responsible for taking a digital photo (possibly displayed in the form of an image 2′) of a display 2 with the mobile phone with an incorporated camera 4 at set time periods, for example 7:00 a.m., 12:00 noon and 7:00 p.m. This mobile phone 4 has MMS technology (multimedia messaging services) with integrated camera, i.e., via a mobile network 6, it can send a digital photo to an electronic messaging address attached to a central monitoring device formed by a computer 5 that can thus also display image 2′. MMS telephone models with integrated camera are sold, for example, under the trademarks Nokia® 7250, Panasonic® GD87 or Ericsson® P800.

There, the digital photo is archived in the computer with a classification indicating the date and time it was sent in a file relating to the site monitored. The computer, of course, processes a large quantity of sites in one or more countries or regions. This classification is done automatically after each photo is sent.

At the level of central monitoring device 5, it is possible to carry out a first step of automatic monitoring to determine whether the photo expected from a site according to the schedule stipulated has been properly received and whether the quality of reception is correct; in the case of a negative response to either one of these questions and after a certain time period, device 5 can send an automatic message 7 over telephone 4, or even trigger an alarm destined for the operator of the central device to call the sales location.

The operator of device 5 responsible for monitoring examines the photos received from the site or sites, continuously or in batches, and, according to whether or not they conform to the standards, he may call (line 8) the site manager 3 to be informed of the reasons for the lack of conformity.

The archived photos and different monitoring parameters can be processed in the form of graphs, histograms, various tables 9 permitting analyzing on a large scale the good application of the commercial standard, and can be integrated into the final report that will be sent to the client.

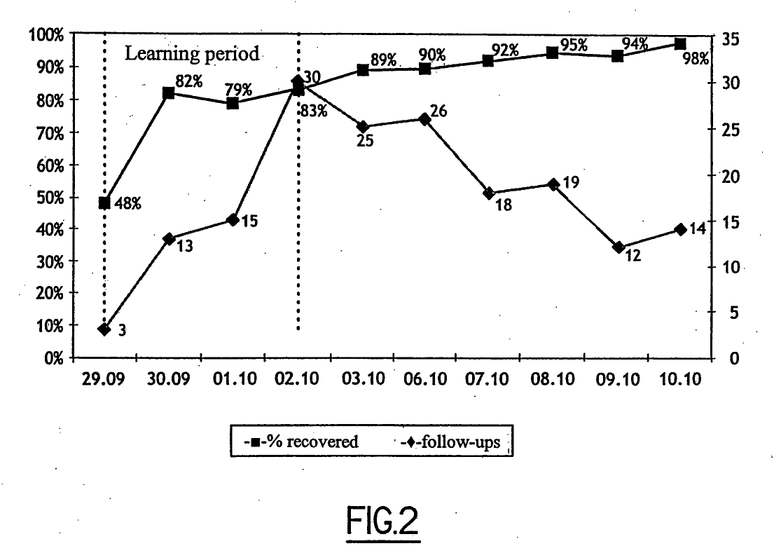

Tests have shown the efficacy of the process according to the invention. FIG. 2 is a graph bearing the date on the abscissa and the percentage of recovered photographs on the ordinate (i.e., the number of photos actually received relative to the number of photographs theoretically expected), on the one hand, and the absolute number of follow-up telephone calls made due to lack of conformity. It is seen in a two-week test that the percentage of recovered photographs, which starts at a relatively low level (48%), is rapidly established at an acceptable level of 80% and better, and even after just one week, more than 90%. With regard to follow-ups, in the first few days a rapidly increasing number of follow-ups are noted, corresponding to a learning period, culminating in 30 follow-ups on the fourth day: the number of follow-ups then decreases to be stabilized at a reasonable number of a dozen follow-ups while the percentage of recovered photographs is maximum.

The process of the invention therefore permits remotely exerting an efficacious and instructive monitoring with a minimum number of personnel.

1. A process for remote monitoring of a location comprising:
transmitting, from a digital photographic device integrated with a mobile multimedia messaging services telephone, to an electronic address corresponding to a central monitoring device, an image that represents a part of a location from which said image is transmitted.

2. The process according to claim 1, further comprising:
comparing said image to a standard, after said image is received at said central monitoring device, and
triggering a telephone call to a device at said location, if said image does not conform to said standard.

3. The process according to claim 1, further comprising taking photographs of said location, and performing said transmitting for said photographs, at periodic intervals.

4. The process according to claim 1, wherein said location is one of a plurality of locations are monitored by said central monitoring device.

5. A device for remote monitoring of a location, comprising a digital photographic device incorporated in a portable multimedia messaging services telephone that records and transmits images representing a part of said location to an electronic address corresponding to a central monitoring device.

6. The process of claim 1, wherein said location is a sales location.

7. The device of claim 5, wherein said location is a sales location.

8. A process for remote monitoring of a location, comprising:
receiving, at an electronic address, an image transmitted from a digital photographic device integrated with a mobile multimedia messaging services telephone, wherein said image represents a part of a location from which said image is transmitted;
comparing said image to a standard; and
triggering a transmission of a message to a device at said location, if said image does not conform to said standard.

9. The process of claim 8, wherein said receiving, comparing and triggering are performed for images transmitted from said digital photographic device at periodic intervals.

10. The process of claim 8,
wherein said location is one of a plurality of locations, and
wherein said receiving, comparing and triggering are performed for images from said plurality of locations.

11. The process of claim 8, wherein said location is a sales location.
